(19) United States
(12) Patent Application Publication
(10) Pub. No.: US 2006/0164440 A1
(43) Pub. Date: Jul. 27, 2006

(54) Method of directly manipulating geometric shapes

(76) Inventors: Steve Sullivan, San Francisco, CA (US); John Horn, Fairfax, CA (US)

Correspondence Address: LAW OFFICES OF MARK C. PICKERING, P.O. BOX 300, PETALUMA, CA, 94953, US

(21) Appl. No.: 11/042,008

(22) Filed: Jan. 25, 2005

(51) Int. Cl. G09G 5/00

(52) U.S. Cl. 345/639

(57) ABSTRACT

An artist directly manipulates the surface of a geometric shape, which is a blended result of a number of weighted shapes, to indicate how the surface of a geometric shape should look. In response to the direct manipulation, the weightings that must be applied to the number of different shapes to produce the manipulated shape are determined, optionally taking into account high-level knowledge and constraints provided by the artist.

### BACKGROUND OF THE INVENTION

1. Field of the Invention

The present invention relates to geometric shapes and, more particularly, to a computer graphics method of directly manipulating geometric shapes.

2. Description of the Related Art

Computer-generated 3D models can represent a geometric shape in a number of ways, such as with a set of vertices of a polygonal mesh, a set of control points on a spline surface, or a set of high-resolution displacements from a low-resolution surface. For example, a human face is a geometric shape that can be represented by a set of vertices, a set of control points, or a set of displacements.

In addition, complex geometric shapes can be represented by combining together a number of global geometric shapes which have been differently weighted. For example, a number of global geometric shapes can include a neutral facial shape that represents a face with a neutral facial expression, a smiling facial shape that represents a face with a smiling facial expression, a surprised facial shape that represents a face with a surprised facial expression, and so on.

To obtain a complex geometric shape that represents a new facial expression, one or more of the global facial shapes are assigned weights, and the shapes are blended together. For example, an interface can provide a dial such that when a global facial shape is selected, the dial is moved to indicate a weighting that is to be assigned to the global facial shape.

As a result, to obtain a look that is half way between a neutral facial shape with a neutral expression and a smiling facial shape with a smiling expression, the neutral shape is given a 0.5 weighting, the smiling shape is given a 0.5 weighting, the remaining shapes are given a zero weighting, and the shapes are blended together.

Similarly, to obtain a look that is part way between a neutral facial shape, a smiling facial shape, and a surprised facial shape, the neutral facial shape is given a 0.33 weighting, the smiling facial shape is given a 0.33 weighting, the surprised facial shape is given a 0.33 weighting, the remaining facial shapes are given a zero weighting, and the shapes are blended together.

Thus, the facial expression of the resulting shape represents a blend of the weighted global facial shapes. As a result, by utilizing a large number of global facial shapes and varying the weighting assigned to each global facial shape, a large number of facial expressions can be formed.

In addition to global geometric shapes, local regions of a global geometric shape, such as the features of a face, can also be represented by a number of shapes, where one or more of the shapes can be selected and weighted to provide an even larger variety of expressions. For example, after selecting and weighting a number of global facial shapes, an artist can select a local shape, such as the mouth, and then select and weight a number of mouth shapes.

Further, regions within the features, such as regions within the mouth shapes, can also be represented by a number of shapes where one or more of the shapes can be selected and weighted. For example, after selecting and weighting a number of mouth shapes, an artist can select a region of the mouth, and then select and weight a number of regional shapes.

Thus, regardless of whether the artist is working with global shapes, local shapes or regional shapes, the artist first selects a shape to change, and then changes the shape via new weightings until the artist is satisfied with the resulting overall geometric shape, e.g., the resulting facial expression.

One drawback of the above-described approach where the artist must adjust weights manually to see the result is that it is time and labor intensive, often requiring the artist to go through many, many iterations where the weights of the various shapes are adjusted one at a time until a result is reached.

In addition, the effect of local shapes must be manually balanced against the effect of global shapes, which can lead to inconsistent animation. Thus, there is a need for an apparatus and method of manipulating geometric shapes that is less time and labor intensive, and more direct than dialing individual weights independently to reach a result.

### SUMMARY OF THE INVENTION

The present invention provides a method of manipulating geometric shapes that is more intuitive for novices, requires less time, and produces more natural results than prior art approaches. The method includes the step of determining whether a shape type has been chosen from a plurality of shape types, where each shape type has a plurality of shapes. When a selected shape type has been chosen, the method includes the step of assigning a plurality of weights to the plurality of shapes associated with the selected shape type. In addition, the method includes the step of blending the shapes based on the plurality of weights to generate an initial surface.

The present invention also includes an apparatus that manipulates shapes. The apparatus includes means for determining whether a shape type has been chosen from a plurality of shape types, where each shape type having a plurality of shapes. The apparatus also includes means for assigning a plurality of weights to the plurality of shapes associated with the selected shape type when a selected shape type has been chosen. The apparatus further includes means for blending the shapes based on the plurality of weights to generate an initial surface.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a flow chart illustrating an example of a method 100 of manipulating geometric shapes in accordance with the present invention.

FIG. 2 is a block diagram illustrating an example of a computer 200 in accordance with the present invention.

### DETAILED DESCRIPTION OF THE INVENTION

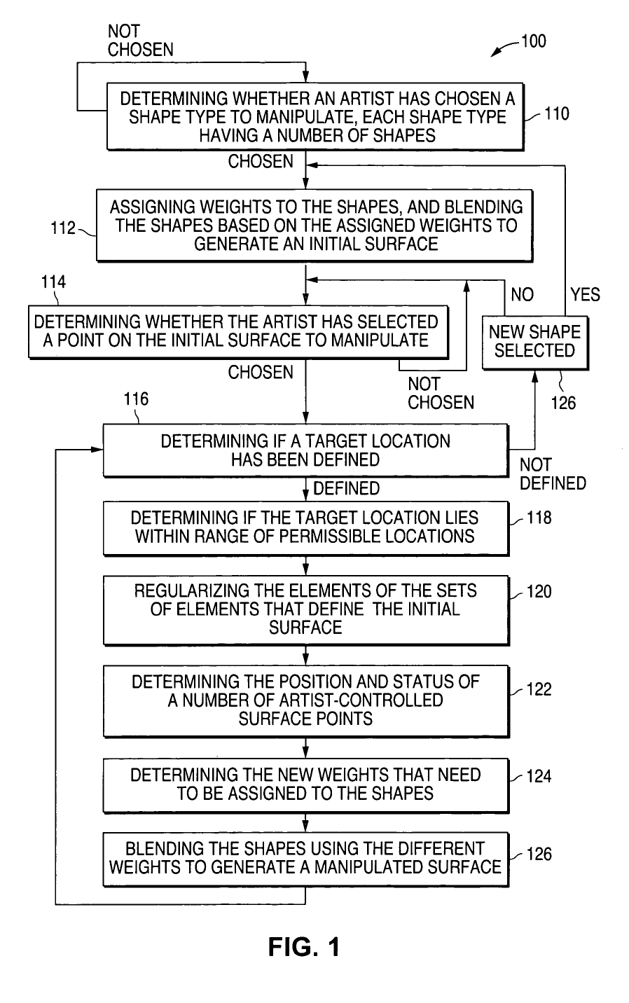

FIG. 1 shows a flow chart that illustrates an example of a method 100 of manipulating geometric shapes in accordance with the present invention. As described in greater detail below, the method of the present invention gives an artist the ability to push surface points on a geometric shape around as though the artist were sculpting the geometric shape.

As shown in FIG. 1, method 100 begins at step 110 by determining whether an artist has chosen a shape type to manipulate from a large number of shape types. For example, when animating a humanoid creature, the artist can select from a facial shape type, an arm shape type, a torso shape type, and the like.

In addition, each shape type includes a number of shapes. For example, a facial shape type can include a number of global facial shapes such as a neutral shape, a smiling shape, and a surprised shape, that represent a neutral expression, a smiling expression, and a surprised expression, respectively. Further, each global facial shape can include a number of local shapes that represent the features of the face, such as the eyes, mouth, and forehead, and a number of regional shapes that represent regions within the features.

In the present invention, a shape, whether global, local, or regional, is defined to mean any geometric representation of a surface which can be linearly combined to form a new surface, such as a set of vertices of a polygonal mesh, a set of control points on a spline surface, or a set of high-resolution displacements from a low-resolution surface. As a result, each shape has a set of elements that define the surface where, for example, the elements can be the vertices in a set of vertices, the control points a set of control points, or the displacements in a set of displacements.

When an artist has chosen a shape type in step 110, method 100 moves to step 112 to assign weights to the shapes (global, local, and regional) that are associated with the chosen shape type, and then blend the shapes together based on the assigned weights to generate an initial surface.

Although the initial surface is a combination of the shapes, the initial surface can represent only one of the global shapes. For example, an initial facial surface can be formed by setting the neutral shape to have a weight of 1.0, the remaining facial shapes to have a weight of zero, and then blending the shapes together. Since the neutral shape is the only weighted shape, the initial surface represents the neutral facial shape.

After method 100 has generated an initial surface in step 112, method 100 moves to step 114 to determine whether the artist has selected a surface point on the initial surface to manipulate. The selected surface point has a source location on the initial surface. (An artist can alternately choose a surface area to manipulate, where the selected surface point represents the surface area. A surface area provides more of a sculpting effect when manipulated than can be obtained from manipulating a surface point.)

When method 100 determines in step 114 that the artist has chosen a selected surface point to manipulate, method 100 moves to step 116 to determine whether a target location for the selected surface point has been defined. The target location represents an artist-requested new location for the selected surface point. For example, when the selected surface point represents a vertex on the surface of a polygonal mesh, the target location represents an artist-requested new location for the vertex.

A target location for the selected surface point can be defined in a number of conventional ways. For example, in a graphical environment, a selected surface point can be dragged from a source location on the initial surface to a target location using a mouse. Alternately, the coordinates of the target location could be specified directly as a set of numbers, provided by a motion capture system, or tracked or even picked manually in 2D images.

When a target location for the selected surface point is defined in step 116, the target location can be identified with varying degrees of specificity. For example, an artist can identify a target location for the selected surface point with a great deal of specificity by defining, for example, a location X, Y, Z in 3D space. In this case, an artist may need the corner of the mouth to be at a specific position in 3D space.

Alternately, an artist can be less specific, and indicate that the surface point at a target location must project back to a specific 2D point. For example, an artist can position a selected surface point, such as the corner of the mouth, to match a picture (a 2D image) of a person. This is not quite as strong a constraint because the target location can lie anywhere along the projection line and provide the same projection.

Further, when an artist utilizes a selected surface point as a surface area, the artist can even be less specific and indicate that the surface area is to be placed in a region. For example, an artist can group together a number of eyebrow points, and then pull the group of points up to a specific 3D region.

When a surface area is placed in a region, method 100 subsequently adjusts the weights of the shapes to get the desired expression, but does not require that every element of the surface area be at a specific location within the 3D region. This is because the shapes in most cases could not actually be weighted to produce, for example, an expression that has a group of eyebrow points pulled up.

The level of specificity can be provided in any mix. Some methods can utilize only 3D space, some methods can utilize only 2D projections, some methods can utilize only surface areas, while other methods can utilize any mix in between. As a result, an artist could actually utilize all three if desired. For example, an artist could pick one surface point and move it in 3D space, take a 2D projection point and move that, and also group a bunch of points together and move them as a surface area.

Following this, when a target location for the selected surface point has been defined, method 100 moves to step 118 to determine whether the target location lies within a range of permissible locations. The permissible range of locations includes all of the locations which can be realized by varying the weights assigned to the different shapes.

As a result, the size of the permissible range of locations is a function of the number of shapes that are available. For example, if only two global facial shapes are available, the permissible range of locations for a selected surface point is limited to the source locations of the corresponding points on the two shapes, and the locations that lie on a line that connects the corresponding source locations together. On the other hand, if a large number of facial shapes are available, a much broader permissible range of locations results.

If the target location for the selected surface point lies outside of the permissible range of locations (e.g., where the facial expression that would result from the target location cannot be realized by altering the weights assigned to the different shapes), the target location is redefined to lie within the permissible range of locations.

For example, method 100 can determine which location of the locations that lie within the permissible range of locations lies closest to the originally desired target location, and then assign this location to be the target location. Thus, in the present embodiment, the target location for the selected surface point can not lie outside of the permissible range of locations.

On the other hand, if the target location for the selected surface point lies within the permissible range of locations (e.g., where the facial expression that results from the target location can be realized by altering the weights assigned to the different shapes), then the defined target location remains unchanged.

In an alternate embodiment, rather than preventing the target location for the selected surface point from lying outside the permissible range of locations, the target location can optionally lie outside of the permissible range of locations. In this embodiment, step 118 can be skipped. Target locations can be either independent of what the shapes are doing, or dependent on what the shapes are doing.

The prior discussion assumed that the target locations are dependent on what the shapes are doing. When dependent and placed outside of the permissible range of locations, a target location can snap back to a location (closest to the original out-of-range position) that lies within the permissible range of locations.

On the other hand, when the target locations are independent of what the shapes are doing, a target location can remain outside of the permissible range of locations. In a cartoon application, an artist may want to keep the target location of the selected surface point outside of the permissible range of locations to let method 100 try and reach a location that it cannot reach, but in the process produce a more extreme result.

For example, the artist can create a character with an expression where the lips jut way out. In this case, the artist can pull the target location of the selected surface point way out beyond the permissible range of locations so that method 100 attempts to solve against a target location sticking way out versus a target location on the lip. The shapes may not be able to curl up and get there exactly right because all these things are combining all across the face, but method 100 can still produce an effect that the artist is trying to achieve.

As a result, the alternate embodiment provides the artist with the option of having the target location of the selected surface point snap back to where the shapes could actually get to so that the artist does not end up with target locations out where they can never be reached, or of allowing the target location to remain outside of the permissible range of locations.

Following this, method 100 moves to step 120 to regularize the elements of the set of elements that define the initial surface. Regularizing is the process of controlling what the rest of a geometric shape does when it is not being manipulated to thereby keep the geometric shape well behaved. In the context of facial shapes, the process of regularizing is the process of controlling what the rest of the face does when it is not being manipulated to thereby keep the face well behaved.

For example, if the definition of a target location (such as by moving a selected surface point with a mouse) causes the left corner of the mouth to rise, the facial regions that are unrelated to the mouth, such as the positions of the eyebrows, should not change dramatically. To insure that some unintended result does not cause the position of the eyebrows to, for example, shoot up unnaturally, a regularizing technique can be utilized.

One approach to regularizing is to randomly lock and/or dampen a different group of elements of the set of elements that define the geometric shape each time step 120 is executed. For example, a different group of vertices of the set of vertices that define a polygonal mesh can be randomly locked or dampened each time step 120 is executed.

By including locked and/or dampened elements within the set, method 100 insures that no unnatural motion can take place, such as the eyebrows shooting up, as a result of defining the target location. In addition, by utilizing different randomly-selected locked and/or dampened elements in the set each time method 100 is performed, method 100 insures that a locked or dampened element which really needs to change (e.g., because the element is close to the selected surface point) is only retarded for one iteration.

Thus, in step 120, method 100 can determine the position of a number of regularizing elements (e.g., 20) of the set of elements that define the geometric shape. In addition, method 100 can also determine the status of the regularizing elements, i.e., whether the regularizing elements are locked (can not be moved), or whether the elements are dampened (can be moved but resist movement).

Regularizing elements can also include elements whose positions, based on prior knowledge, are limited as a result of being related to the positions of its neighboring elements, and elements whose velocities, based on prior knowledge, are limited as a result of being related to the positions of its neighboring elements.

Following step 120, method 100 moves to step 122 to determine the position and status of a number of artist-controlled surface points, such as surface points the artist has specified as locked or dampened. For example, after an artist has chosen a first selected surface point and defined a first target location for the selected surface point, the artist can lock the first selected surface point at the first target location to keep the surface at that point from moving when the artist chooses a subsequent selected surface point and moves it to a target location.

After this, method 100 moves to step 124 to determine the new weights that need to be assigned to the shapes to obtain a blended shape, such as a new facial expression, that reflects the definition of the target location, the regularizing elements (the elements which can not be changed or changed only slightly), and the artist-controlled surface points (the surface points which have no or limited movement).

Method 100 can determine the new weights that need to be assigned to the shapes, i.e., can determine the new mix of shapes, by solving a linear least-squares equation using the global, local, and regional shapes, the source location, the target location, the constraints provided by the regularizing elements, and the constraints provided by any artist-controlled surface points. (The specific equation used to determine the new weights is not part of the invention, and is well within the ordinary skill in the art to construct given the teachings of the present invention.)

In solving the linear least-squares equation, the elements of the set of elements that define the geometric shape are also constrained so that an element that lies close to the selected surface point has more freedom to change than an element that lies far away from the selected surface point. Thus, an element that is not locked or dampened is still constrained based on its proximity to the selected surface point. In addition, elements that are near elements which have been locked or dampened are also constrained more than elements which lie further away from a locked or dampened element.

Further, since some shapes affect the entire face while other shapes affect only small portions of the face, and some shapes are more repetitive than others, method 100 can first try to solve the linear equation and determine the new weights using fewer than all of the available shapes.

For example, method 100 can attempt to solve the linear equation and determine the new weights using only a few of the global facial shapes, or only the global shapes that have been frequently utilized. If a good solution can not be obtained using a limited set of shapes, method 100 can add additional shapes until a good solution is reached.

In addition, an equation with non-linear terms can alternately be solved to determine the new weights that need to be assigned. The nonlinear terms apply to other regularization types where, for example, the change in curvature over the face is minimized to limit a wrinkly behavior. Thus, keeping the curvature smooth requires a nonlinear term which, in turn, leads to a nonlinear solution.

After weights have been assigned to the different shapes in step 124, method 100 moves to step 126 to blend the shapes using the different weights to generate a manipulated surface. The manipulated surface that results is represented by a new set of elements (which can be stored as differences), such as a set of vertices, a set of control points, or a set of displacements, where some or all of the elements have changed from the previous set.

Each of the changed elements represents a combination of corresponding elements from the shapes based on the weighting, and has a calculated location that results from defining the target location. One of the changed elements corresponds with the selected surface point at the target location, and has a calculated location that is at or near the target location. (The calculated location almost never matches the target location exactly.)

Returning again to FIG. 1, if at step 116 method 100 determines that a target location for the selected surface point has not been defined, method 100 moves to step 126 to determine if the artist has selected a new shape type. When a new shape type has been selected, method 100 again returns to step 112. On the other hand, when a new shape type has not been selected, method 100 returns to step 114.

In a graphical interface example, an artist can define a target location for the selected surface point by moving the selected surface point from the source location to the target location using a mouse. In this example, a repositioning period is required for the artist to move the selected surface point from the source location to the target location. In this example, method 100 periodically takes the current location of the mouse as the target location so that method 100 is iteratively performed a large number of times during the repositioning period.

As a result, during the repositioning period, method 100 defines a series of target locations for the selected surface point. The series of target locations ends when the selected surface point comes to rest, as indicated by when the mouse stops moving. As a result, changes in a graphically-displayed surface, such as changes in the expression of a face, that occur as a result of moving the selected surface point with a mouse appear to occur to the artist in real time.

The present invention can also be used to diagnose the available set of shapes. For example, if method 100 is unable to obtain an expression that an artist has sculpted, additional shapes need to added to the shape set. Thus, in addition to using method 100 to sculpt, method 100 can also be used to evaluate the shapes that are needed.

In addition to sculpting and diagnosing, method 100 can also be used for animation. For example, in a static setting, if an artist wants to change from a neutral facial shape to a manipulated facial shape that is a blend of other facial shapes, such as a blended facial shape that shows the corners of the mouth pulled up, the artist can push the face around as described above with respect to the present invention until the desired expression has been achieved.

Similarly, in an animation setting, an animator can set up, for example, key frame 1 to have the neutral facial shape and key frame 10 to have the blended facial shape that shows the corners of the mouth pulled up. The result on key frame 10 is exactly the same as if the corners of the mouth had been pulled up on key frame 1 in a static setting. There is no difference.

Once the key frames have been defined, linear interpolation can then be used to generate the in-between frames. To prevent the interpolation process from generating in-between frames which have shapes with an unnatural look, the same constraints are applied to the interpolation process as are applied to the method of generating a new expression.

For example, if one of the facial shapes is the dominant shape in both key frames 1 and 10, then the same facial shape should be the dominant shape throughout the in-between frames when the same constraints are applied. In the event that an unnatural shape is present in an in-between frame, the artist can adjust key frame 10 slightly to force the generation of a new set of in-between frames, or convert an in-between frame, such as frame 5, to a key frame.

As a result, the whole sequence of operations of the present invention can be useful either in creating an animation of someone smiling or of just getting the face into the configuration of a smile. Thus, the present invention can be used for setting a pose or for setting up an animation.

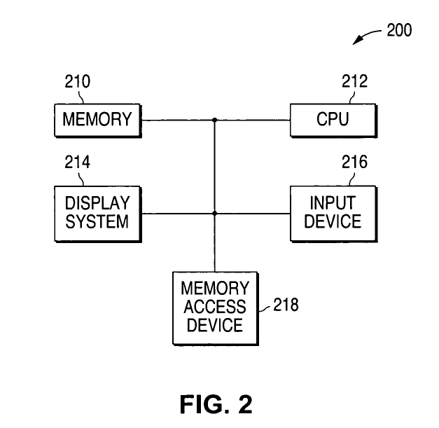

FIG. 2 shows a block diagram that illustrates an example of a computer 200 in accordance with the present invention. Computer 200, which can be implemented with, for example, a Pentium4 3.4 GHz or comparable machine, executes software that implements method 100 of the present invention.

As shown in FIG. 2, computer 200 includes a memory 210 and a central processing unit (CPU) 212 that is connected to memory 210. Memory 210 stores data, an operating system, and a set of program instructions. The operating system can be implemented with, for example, the Linux operating system, although other operating systems can alternately be used. The program instructions can be written in, for example, C++ although other languages can alternately be used.

CPU 212, which can be implemented with, for example, a 32-bit processor, operates on the data in response to the program instructions. Although only one processor is described, the present invention can be implemented with multiple processors in parallel to increase the capacity to process large amounts of data.

In addition, computer 200 includes a display system 214 that is connected to CPU 212. Display system 214, which can be remotely located, allows images to be displayed to the user which are necessary for the user to interact with the program. Computer 200 also includes a user-input system 216 which is connected to CPU 212. Input system 216, which can be remotely located, allows the user to interact with the program.

Further, computer 200 includes a memory access device 218, such as a disk drive or a networking card, which is connected to memory 210 and CPU 212. Memory access device 218 allows the processed data from memory 210 or CPU 212 to be transferred to an external medium, such as a disk or a networked computer. In addition, device 218 allows the program instructions to be transferred to memory 210 from the external medium.

It should be understood that the above descriptions are examples of the present invention, and that various alternatives of the invention described herein may be employed in practicing the invention. For example, although the present invention has often used examples of facial shapes, the present invention is not limited to facial shapes, but applies equally to any other geometric shape. Thus, it is intended that the following claims define the scope of the invention and that structures and methods within the scope of these claims and their equivalents be covered thereby.

What is claimed is:

1. A method of manipulating shapes, the method comprising the steps of:
determining whether a shape type has been chosen from a plurality of shape types, each shape type having a plurality of shapes;
when a selected shape type has been chosen, assigning a plurality of weights to the plurality of shapes associated with the selected shape type; and
blending the shapes based on the plurality of weights to generate an initial surface.

2. The method of claim 1 and further including the steps of:
determining whether a point on the initial surface has been chosen as a selected surface point, the selected surface point having a source location; and
when a selected surface point has been chosen, determining whether a target location for the selected surface point has been defined, the target location representing a requested new position of the selected surface point.

3. The method of claim 2 wherein the target location for the selected surface point is defined by graphically moving the selected source point from the source location to the target location.

4. The method of claim 3 wherein the selected surface point includes a surface area.

5. The method of claim 2 and further comprising the step of determining if the target location for the selected surface point lies within a permissible range of locations.

6. The method of claim 5 wherein when the target location is defined outside of the permissible range of locations, an assigned location within the permissible range of locations is assigned to be the target location.

7. The method of claim 6 wherein the assigned location within the permissible range of locations lies closer to the target location than any other location within the permissible range of locations.

8. The method of claim 5 and further comprising the step of determining a position and status of a plurality of regularizing elements of a set of regularizing elements that define the initial surface.

9. The method of claim 8 and further comprising the step of determining a position and status of a plurality of user-controlled surface points on the initial surface.

10. The method of claim 11 and further comprising the step of determining the plurality of weights to be assigned to the plurality of shapes to obtain a look that reflects a definition of the target location, the plurality of weights being assigned to the plurality of shapes after the plurality of weights have been determined.

11. The method of claim 10 and further comprising the step of blending the plurality of shapes using the plurality of weights to generate a manipulated surface.

12. The method of claim 11 wherein the manipulated surface is defined by a plurality of elements, each element representing a combination of corresponding elements from the shapes based on the weighting.

13. The method of claim 2 and further comprising the step of determining the plurality of weights to be assigned to the plurality of shapes to obtain a look that reflects a definition of the target location, the plurality of weights being assigned to the plurality of shapes after the plurality of weights have been determined.

14. The method of claim 13 and further comprising the step of blending the plurality of shapes using the plurality of weights to generate a manipulated surface.

15. The method of claim 14 wherein the initial surface is formed in a first key frame, and the manipulated surface is formed in a subsequent key frame, the first key frame and the subsequent key frame being spaced apart.

16. The method of claim 14 wherein additional shapes are added to the plurality of shapes if the manipulated surface can not produce a desired surface.

17. An apparatus that manipulates shapes, the apparatus comprising:
means for determining whether a shape type has been chosen from a plurality of shape types, each shape type having a plurality of shapes;
when a selected shape type has been chosen, means for assigning a plurality of weights to the plurality of shapes associated with the selected shape type; and
means for blending the shapes based on the plurality of weights to generate an initial surface.
